(19) United States
(12) Patent Application Publication
(10) Pub. No.: US 2026/0005369 A1
(43) Pub. Date: Jan. 1, 2026

(54) STANDOFFS FOR IMMERSION THERMAL MANAGEMENT SYSTEM OF TRACTION BATTERY PACK

(71) Applicant: Ford Global Technologies, LLC, Dearborn, MI (US)

(72) Inventor: Jie Deng, Novi, MI (US)

(21) Appl. No.: 18/760,739

(22) Filed: Jul. 1, 2024

(51) Int. Cl. H01M 50/249; H01M 10/613; H01M 10/625; H01M 10/6557; H01M 50/209

(52) U.S. Cl. CPC H01M 50/249; H01M 10/613; H01M 10/625; H01M 10/6557; H01M 50/209; H01M 2220/20

(57) ABSTRACT

A traction battery pack assembly includes an enclosure assembly having an enclosure wall. A cell stack is within an interior of the enclosure assembly. The cell stack has one or more battery cells disposed along a cell stack axis. The assembly further includes a support sheet and a plurality of standoffs disposed between the cell stack and an area of the enclosure assembly.

### TECHNICAL FIELD

This disclosure details exemplary assemblies and methods that establish areas for immersion coolant fluid to flow within a battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack assembly, including: an enclosure assembly having an enclosure wall; a cell stack within an interior of the enclosure assembly, the cell stack having one or more battery cells disposed along a cell stack axis; a support sheet; and a plurality of standoffs disposed between the cell stack and an area of the enclosure assembly.

In some aspects, the techniques described herein relate to a traction battery pack assembly, wherein the plurality of standoffs project from the enclosure wall and are part of the enclosure assembly.

In some aspects, the techniques described herein relate to a traction battery pack assembly, wherein the enclosure assembly is an enclosure tray.

In some aspects, the techniques described herein relate to a traction battery pack assembly, wherein the plurality of standoffs and the enclosure assembly are parts of a singular, monolithic structure.

In some aspects, the techniques described herein relate to a traction battery pack assembly, wherein the enclosure assembly is a cast enclosure assembly.

In some aspects, the techniques described herein relate to a traction battery pack assembly, wherein the support sheet rests on the plurality of standoffs at a positions spaced from the enclosure wall.

In some aspects, the techniques described herein relate to a traction battery pack assembly, wherein the support sheet establishes a first side of at least one immersion coolant channel and the enclosure assembly establishes an opposite, second side of the at least one immersion coolant channel.

In some aspects, the techniques described herein relate to a traction battery pack assembly, further including a liquid coolant within the at least one immersion coolant channel.

In some aspects, the techniques described herein relate to a traction battery pack assembly, wherein the plurality of standoffs establish a third side and an opposite fourth side of the at least one immersion coolant channel.

In some aspects, the techniques described herein relate to a traction battery pack assembly, wherein the one or more battery cells are one or more pouch-style battery cells.

In some aspects, the techniques described herein relate to a traction battery pack assembly, wherein the plurality of standoffs is a first plurality of standoffs that is above the cell stack, and further including a second plurality of standoffs that is beneath the cell stack.

In some aspects, the techniques described herein relate to a traction battery pack assembly, further including a thermal interface material between the support sheet and the plurality of standoffs and the one or more battery cells.

In some aspects, the techniques described herein relate to a traction battery pack assembly, wherein the enclosure assembly includes an enclosure cover and an enclosure tray that cooperate to provide an enclosed internal area that houses the cell stack.

In some aspects, the techniques described herein relate to a traction battery pack assembly, wherein the plurality of standoffs is a first plurality of standoffs that is disposed between the enclosure cover and the cell stack, and further including a second plurality of standoffs that is disposed between the enclosure tray and the cell stack.

In some aspects, the techniques described herein relate to a traction battery pack assembly, wherein the plurality of standoffs project from the support sheet and are part of the support sheet.

In some aspects, the techniques described herein relate to a traction battery pack assembly, wherein the plurality of standoffs are disposed along an axis that is angled relative to the cell stack axis.

In some aspects, the techniques described herein relate to a traction battery pack assembly, wherein the plurality of standoffs includes plurality of elongated standoffs.

In some aspects, the techniques described herein relate to a method of managing thermal energy within a traction battery pack, including: immersing at least a portion of a cell stack within a liquid coolant to manage thermal energy within the cell stack, the cell stack including one or more battery cells disposed along a cell stack axis, the cell stack housed within an enclosure assembly; supporting the cell stack within the enclosure assembly upon a support sheet; resting the support sheet on a plurality of standoffs; and communicating the liquid coolant through channels provided between the enclosure assembly and the support sheet.

In some aspects, the techniques described herein relate to a method, wherein the support sheet distributes forces from the plurality of standoffs to the cell stack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1.

FIG. 3 illustrates a section view at line 3-3 in FIG. 2 showing a cell stack of the battery pack within an enclosure of the battery pack between first and second pluralities of standoffs according to an exemplary aspect of the present disclosure.

FIG. 4 illustrates an expanded view of the battery pack of FIG. 1.

FIG. 5 illustrates a close-up view of an area of FIG. 3.

FIG. 6-6C illustrate interior views of a tray of the enclosure according to four exemplary embodiments.

### DETAILED DESCRIPTION

An immersion thermal management system can be used to manage thermal energy in a traction battery pack. The immersion thermal management system immerses at least some components, such as battery cells, of the traction battery pack in a liquid coolant. This disclosure is directed toward established channels for the immersion coolant to move through the battery pack.

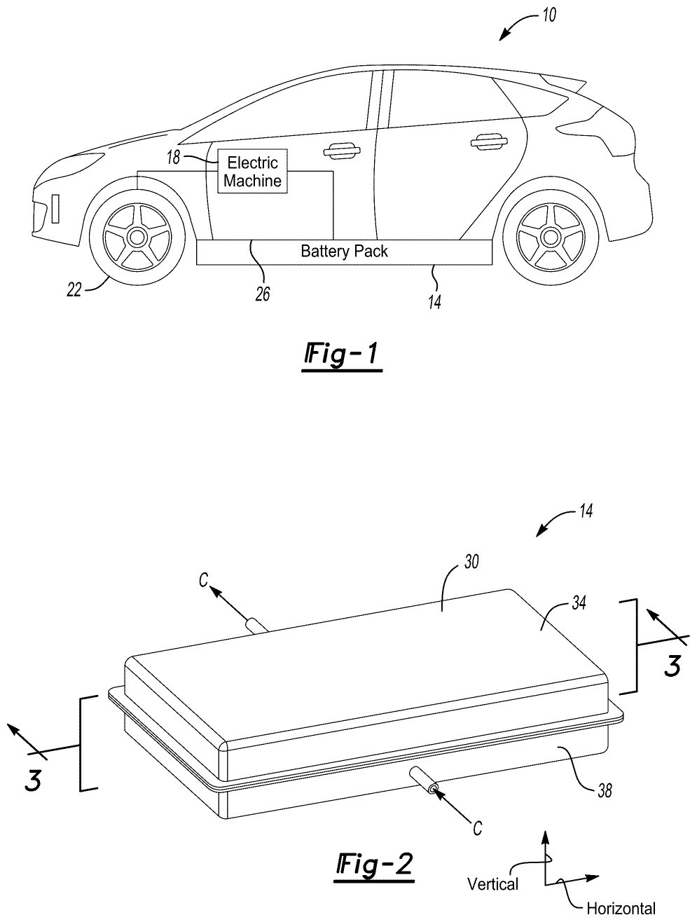

With reference to FIG. 1, an electrified vehicle 10 includes a traction battery pack 14, an electric machine 18, and wheels 22. The traction battery pack 14 powers the electric machine 18, which can convert electrical power to mechanical power to drive the wheels 22.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

The traction battery pack 14 is, in the exemplary embodiment, secured to an underbody 26 of the electrified vehicle 10. The traction battery pack 14 could be located elsewhere on the electrified vehicle 10 in other examples.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

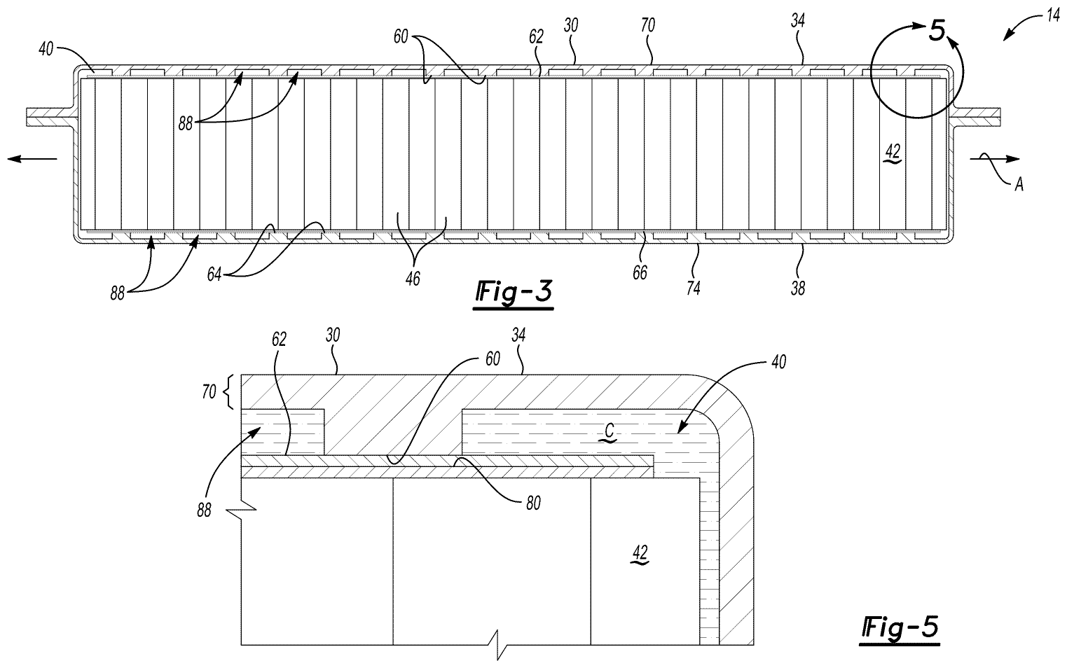

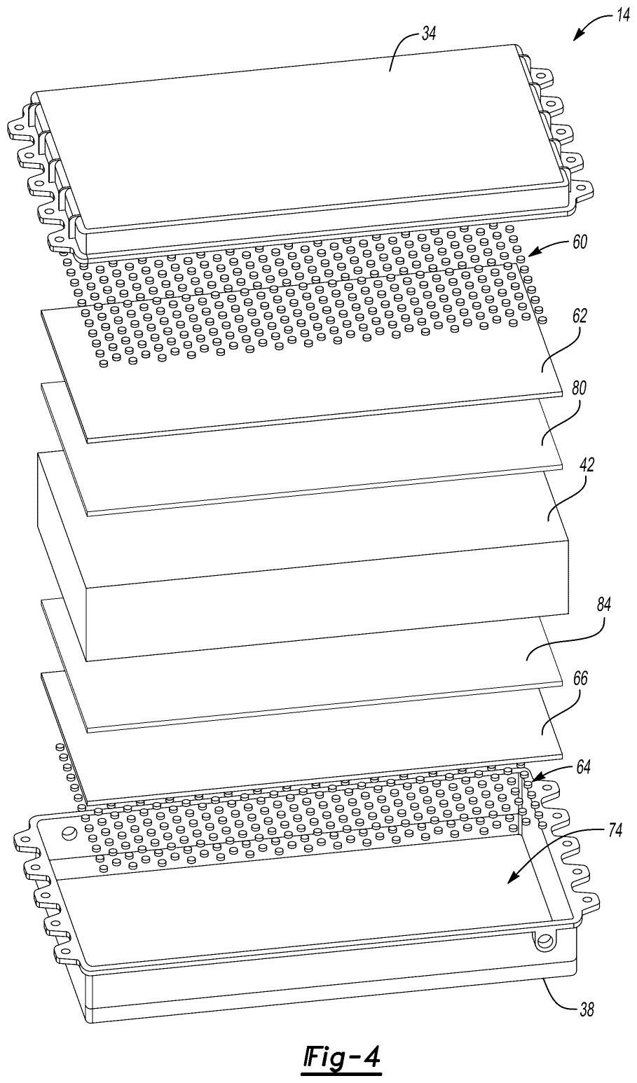

Referring now to FIGS. 2-6, the battery pack 14 includes an enclosure assembly 30 having a cover 34 and a tray 38. The cover 34, in this example, is vertically above the tray 38. In other examples, however, the cover 34 could be arranged below, or to a side of the tray 38.

Vertical is with reference to ground and a general orientation of the vehicle 10 and the battery pack 14 during operation. Various terms such as “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1.

The cover 34 and the tray 38 are a metal or metal alloy in this example. In other examples, one or both of the cover 34 and the tray 38 can be a polymer-based material, or some other material. The cover 34 is secured to the tray 38 using adhesive and mechanical fasteners in one example of this disclosure. The cover 34 and tray 38 could be connected using other fluid-tight connection techniques in other examples. Further, while an exemplary enclosure assembly 30 is shown in the drawings, the enclosure assembly 30 may vary in size, shape, and configuration within the scope of this disclosure. The cover 34, for example, could include multiple separate pieces that, when combined, provide the cover 34.

In this disclosure, the traction battery pack 14 includes at least one cell stack 42 having one or more individual battery cells 46 disposed along a cell stack axis A. The cover 34 and the tray 38 cooperate to provide an enclosed internal area 40 that houses the cell stack 42.

The cell stack 42 could include any number of battery cells 46. The battery pack 14 could also employ any number of cell stacks 42 within the enclosure assembly 30. Thus, this disclosure is not limited to the exact configuration shown. Further, while the battery cells 46 of the exemplary embodiment are positioned side-by-side relative to one another along the cell stack axis A, other configurations are also contemplated within the scope of this disclosure, including but not limited to embodiments in which the battery cells 46 are stacked on top of one another, for example.

In an embodiment, the battery cells 46 are pouch-style, lithium-ion cells. However, battery cells having other form-factors (cylindrical, prismatic, etc.), other chemistries (nickel-metal hydride, lead-acid, etc.), or both could alternatively be utilized within the scope of this disclosure.

The cell stack 42 can further include a plurality of dividers disposed between the battery cells 46 and endplates at opposite ends of the cell stack 42. The dividers can be foam. The dividers and the battery cells 46 are sandwiched between the endplates along the cell stack axis.

The cell stack 42 is arranged in the interior area 40 of the enclosure assembly 30 between the tray 38 and the cover 34. During operation, a thermal management system can route non-conductive (i.e., dielectric) coolant C through the interior area 40 over areas of the cell stack 42 to manage thermal energy within the cell stack 42. The coolant C can, for example, take on heat from the cell stack 42 to cool the cell stack 42.

The thermal management system is an immersion thermal management system at least because portions of the battery pack 14, here at least the battery cells 46 of the cell stack 42 are immersed in the coolant C.

The coolant C is a dielectric fluid in this example. The coolant can be an oil. The coolant can be non-conductive and can be a liquid that is designed for immersion cooling of the battery cells 46 and other components. The chemical makeup and design characteristics (e.g., dielectric constant, maximum breakdown strength, boiling point, etc.) of the coolant C can vary depending on the environment that the battery pack 14 is designed to be utilized in. Unlike some conductive glycol coolants utilized within cold plate cooling systems, the coolant C of the exemplary embodiment is designed for immersion cooling and allows for direct contact with the battery cells 46 and other electrified components.

In an example, the coolant C takes on thermal energy from components within the interior of the enclosure assembly 30 and is then routed to, for example, a heat exchanger outside the battery pack 14. At the heat exchanger, thermal energy is release from the coolant C. The coolant C is then recirculated back through the interior area 40.

Within the interior area 40, the battery pack 14 further includes a first plurality of standoffs 60, a first support sheet 62, a second plurality of standoffs 64, and a second support sheet 66 that can help to support and position the cell stack 42. In the exemplary embodiment, the first plurality of standoffs 60 and the first support sheet 62 are vertically above the cell stack 42 between the cell stack 42 and the cover 34. The second plurality of standoffs 64 and the second support sheet 66 are vertically beneath the cell stack 42 between the cell stack 42 and the tray 38.

The battery pack 14, in another example, could include one plurality of standoffs and one support sheet, or more than two pluralities of standoffs and more than two support sheets.

In this example, the first plurality of standoffs 60 and the second plurality of standoffs are part of the enclosure assembly 30, which can be a metal or metal alloy. The first plurality of standoffs 60 and the second plurality of standoffs 64 are, in this example, a metal or metal alloy material.

In particular, the cover 34 includes the first plurality of standoffs 60 and an enclosure wall 70. The first plurality of standoffs 60 project from the enclosure wall 70 such that the first plurality of standoffs 60 project from an area of the enclosure assembly 30—here the enclosure wall 70 of the cover 34.

The first plurality of standoffs 60, the enclosure wall 70, and the remaining portions of the cover 34 can be cast together as a single monolithic component. A person having skill in this art would understand how to structurally distinguish a cast component from a component that is not cast. Thus, describing cover 34 as being a cast cover implicates structure to the cover 34. In another example, the first plurality of standoffs 60 can be stamped standoffs.

The second plurality of standoffs 64, in this example, project from an enclosure wall 74 of the tray 38. The enclosure wall 74 the second plurality of standoffs 64 and the remaining portions of the tray 38 can be cast together to provide the enclosure wall 74 and the second plurality of standoffs 64 as a single structure.

The first support sheet 62 is disposed between the first plurality of standoffs 60 and the cell stack 42. A thermal interface material layer 80 can be positioned between the cell stack 42 and the first support sheet 62. The first support sheet 62 distribute loads passing between the cell stack 42 and the first plurality of standoffs 60. If the first support sheet 62 were omitted, more focused point loads would pass between the first plurality of standoffs 60 and the cell stack 42. The first support sheet 62 can be a metal or metal alloy. The first support sheet 62 can be attached to the first plurality of standoffs 60 with an adhesive, for example.

The second support sheet 66 rests on the second plurality of standoffs 64. The cell stack 42 is then supported on the second support sheet 66. A thermal interface material layer 84 can be sandwiched between the second support sheet 66 and the cell stack 42. The second plurality of standoffs 64 are positioned between the cell stack 42 and an area of the tray 38—here an enclosure wall 74 of the tray 38. The second plurality of standoffs 64 keep the second support sheet 66 spaced from the enclosure wall 74. The second support sheet 66 can be attached to the second plurality of standoffs 64.

The first plurality of standoffs 60 and the second plurality of standoffs 64 establish channels 88 for communicating the coolant C over and under the cell stack 42 in this example.

While the example first plurality of standoffs 60 are part of the enclosure assembly 30, the first plurality of standoffs 60 could instead or additionally be part of the first support sheet 62. The first plurality of standoffs 60, the first support sheet 62, and the cover 34 could be different areas of a single component, for example. The first plurality of standoffs 60 could be part of the first support sheet 62, or separate from both the cover 34 and the first support sheet 62. Similarly, the second plurality of standoffs could instead or additionally be part of the second support sheet 66.

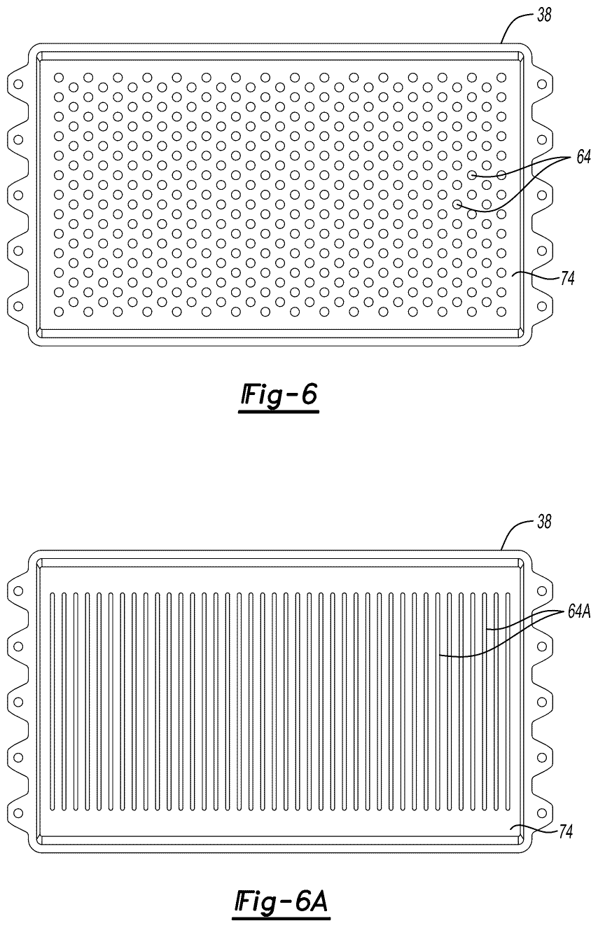

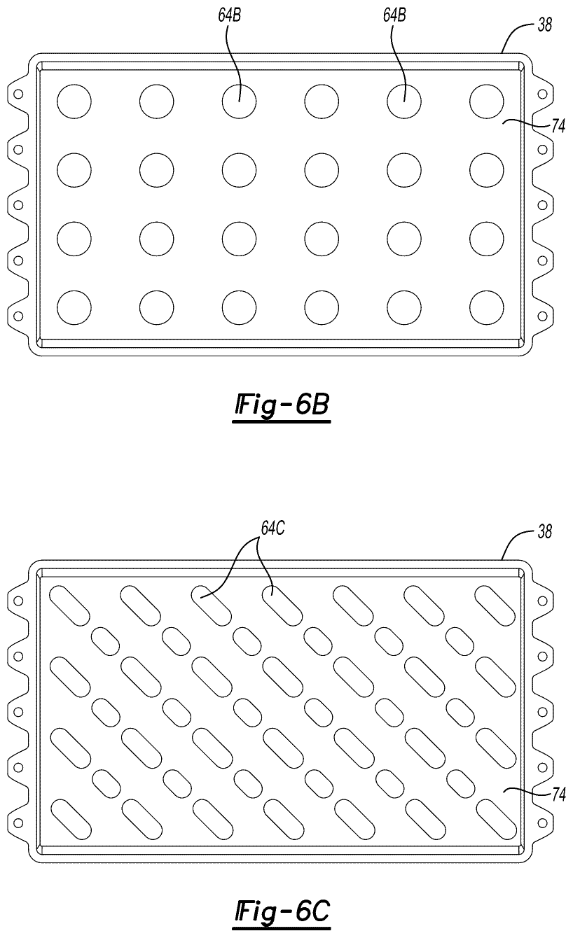

In this example, the first plurality of standoffs 60 and the second plurality of standoffs 64 have circular profiles as shown in FIG. 6. FIG. 6A shows a second plurality of standoffs 64A that extend longitudinally according to another exemplary aspect of the present disclosure. FIG. 6B illustrates a second plurality of standoffs 64B according to another exemplary aspect of the present disclosure where the standoffs 64B. are circular like the embodiment of FIG. 6, but have larger diameters. FIG. 6C illustrates a second plurality of standoffs 64C according to yet another exemplary aspect of the present disclosure. In the embodiment of FIG. 6C, the standoffs 64C are elongated different amounts and are disposed along lines that are angled relative to the cell stack axis A, which provides angled channels.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure assembly having an enclosure wall;
a cell stack within an interior of the enclosure assembly, the cell stack having one or more battery cells disposed along a cell stack axis;
a support sheet; and
a plurality of standoffs disposed between the cell stack and an area of the enclosure assembly.

2. The traction battery pack assembly of claim 1, wherein the plurality of standoffs project from the enclosure wall and are part of the enclosure assembly.

3. The traction battery pack assembly of claim 2, wherein the enclosure assembly is an enclosure tray.

4. The traction battery pack assembly of claim 2, wherein the plurality of standoffs and the enclosure assembly are parts of a singular, monolithic structure.

5. The traction battery pack assembly of claim 2, wherein the enclosure assembly is a cast enclosure assembly.

6. The traction battery pack assembly of claim 1, wherein the support sheet rests on the plurality of standoffs at a positions spaced from the enclosure wall.

7. The traction battery pack assembly of claim 1, wherein the support sheet establishes a first side of at least one immersion coolant channel and the enclosure assembly establishes an opposite, second side of the at least one immersion coolant channel.

8. The traction battery pack assembly of claim 7, further comprising a liquid coolant within the at least one immersion coolant channel.

9. The traction battery pack assembly of claim 7, wherein the plurality of standoffs establish a third side and an opposite fourth side of the at least one immersion coolant channel.

10. The traction battery pack assembly of claim 1, wherein the one or more battery cells are one or more pouch-style battery cells.

11. The traction battery pack assembly of claim 1, wherein the plurality of standoffs is a first plurality of standoffs that is above the cell stack, and further comprising a second plurality of standoffs that is beneath the cell stack.

12. The traction battery pack assembly of claim 1, further comprising a thermal interface material between the support sheet and the one or more battery cells.

13. The traction battery pack assembly of claim 1, wherein the enclosure assembly includes an enclosure cover and an enclosure tray that cooperate to provide an enclosed internal area that houses the cell stack.

14. The traction battery pack assembly of claim 13, wherein the plurality of standoffs is a first plurality of standoffs that is disposed between the enclosure cover and the cell stack, and further comprising a second plurality of standoffs that is disposed between the enclosure tray and the cell stack.

15. The traction battery pack assembly of claim 1, wherein the plurality of standoffs project from the support sheet and are part of the support sheet.

16. The traction battery pack assembly of claim 1, wherein the plurality of standoffs are disposed along an axis that is angled relative to the cell stack axis.

17. The traction battery pack assembly of claim 1, wherein the plurality of standoffs comprises plurality of elongated standoffs.

18. A method of managing thermal energy within a traction battery pack, comprising:
immersing at least a portion of a cell stack within a liquid coolant to manage thermal energy within the cell stack, the cell stack including one or more battery cells disposed along a cell stack axis, the cell stack housed within an enclosure assembly;
supporting the cell stack within the enclosure assembly upon a support sheet;
resting the support sheet on a plurality of standoffs; and
communicating the liquid coolant through channels provided between the enclosure assembly and the support sheet.

19. The method of claim 18, wherein the support sheet distributes forces from the plurality of standoffs to the cell stack.
